(19) United States
(12) Patent Application Publication
(10) Pub. No.: US 2011/0003177 A1
(43) Pub. Date: Jan. 6, 2011

(54) METHOD FOR PRODUCING SPUTTERING TARGET CONTAINING BORON, THIN FILM AND MAGNETIC RECORDING MEDIA

(75) Inventors: Ming-Wei Wu, Tainan (TW); Hao-Chia Liao, Tainan (TW)

Correspondence Address: RABIN & Berdo, PC, 1101 14TH STREET, NW, SUITE 500, WASHINGTON, DC, 20005, US

(73) Assignee: SOLAR APPLIED MATERIALS TECHNOLOGY CORP., Tainan (TW)

(21) Appl. No.: 12/497,866

(22) Filed: Jul. 6, 2009

(51) Int. Cl. G11B 5/65; B22F 3/12

(52) U.S. Cl. 428/836.2; 419/19; 75/233

(57) ABSTRACT

A method for producing a sputtering target containing boron has steps of providing cobalt-chromium (Co·Cr) prealloy powder, mixing Co·Cr prealloy powder and raw material powder containing boron and oxide to form a mixture, preforming the mixture to form a green compact, and sintering the green compact to obtain the sputtering target containing boron. Because Co·Cr prealloy powder is provided, then is mixed with boron, oxide or the like, size and distribution of boride particles can be efficiently controlled. Therefore, Co, Cr, B or the like are uniformly distributed in the sputtering target.

### BACKGROUND OF THE INVENTION

1. Field of Invention

The present invention relates to a method for producing a sputtering target containing boron, and more particularly to a method for producing a sputtering target containing uniformly distributed boron (B), cobalt (Co) and chromium (Cr) with.

2. Description of the Related Art

Conventional cobalt-chromium-platinum oxide (CoCrPt-oxide) composite material is used to form a recording layer in a perpendicular magnetic recording media. In industry, the recording layer is formed by sputtering. However, a sputtering target made of CoCrPt-oxide composite material contains insulating ceramic substance, so arcing and particles are easily generated during direct-current (DC) magnetron sputtering. In order to avoid the foregoing disadvantages, US Publication No. 2004/112,734 discloses that CoCrPt-oxide sputtering target has oxide phase with a dimension less than 10 μm. Furthermore, components of sputtering target disperse homogeneously, which will form a uniform recording layer.

For obtaining a magnetic recording media with high density, boron (B) is added in the CoCrPt-oxide allowing magnetic crystals to separate better. However, a conventional method comprises mixing powders of Co, Cr, Pt, B and oxides to form a mixture and sintering the mixture to obtain a sputtering target. The sputtering target has more than 20 μm of Co·Cr·B alloy phase, which results in inhomogeneous sputtering target. Therefore, arcing and particles will be generated during sputtering.

U.S. Pat. No. 6,797,137 and US Re 40100 disclose a rapid solidification, which leads to chemically homogeneous fine powders containing fine precipitates. The rapid solidification such as gas atomization is used to form Co—B powders and/or Co·Cr—B powders serving as raw materials. The raw materials are sintered to form a sputtering target with fine boride phase. However, the methods are used to produce a sputtering target without oxides and cannot be used for producing a sputtering target with oxides.

To overcome the shortcomings, the present invention provides a method for producing a sputtering target containing boron to mitigate or obviate the aforementioned.

### SUMMARY OF THE INVENTION

The primary objective of the present invention is to provide a method for producing a sputtering target containing uniformly distributed boron (B), cobalt (Co) and chromium (Cr).

To achieve the objective, the method for producing a sputtering target containing B in accordance with the present invention comprises steps of providing cobalt-chromium (Co·Cr) prealloy powder, mixing Co·Cr prealloy powder and raw material powder containing boron and oxide to form a mixture, preforming the mixture to form a green compact, and sintering the green compact to obtain the sputtering target containing boron.

Because Co·Cr prealloy powder is provided, then is mixed with boron, oxide or the like, size and distribution of boride particles can be efficiently controlled. Therefore, Co, Cr, B or the like are uniformly distributed in the sputtering target.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a method for producing a sputtering target containing boron in accordance with the present invention;

FIG. 2 is a metallographic microscope image of a conventional sputtering target in comparative example 1 in accordance with the prior art;

FIG. 3 is a metallographic microscope image of a sputtering target in example 1 in accordance with the present invention;

FIG. 4A is an electron probe microanalysis (EPMA) of a conventional sputtering target in comparative example 1 in accordance with the prior art;

FIG. 4B is an electron probe microanalysis (EPMA) in example 1 in accordance with the present invention; and

FIG. 5 is a metallographic microscope image of a sputtering target in example 2 in accordance with the present invention.

### DETAILED DESCRIPTION OF THE INVENTION

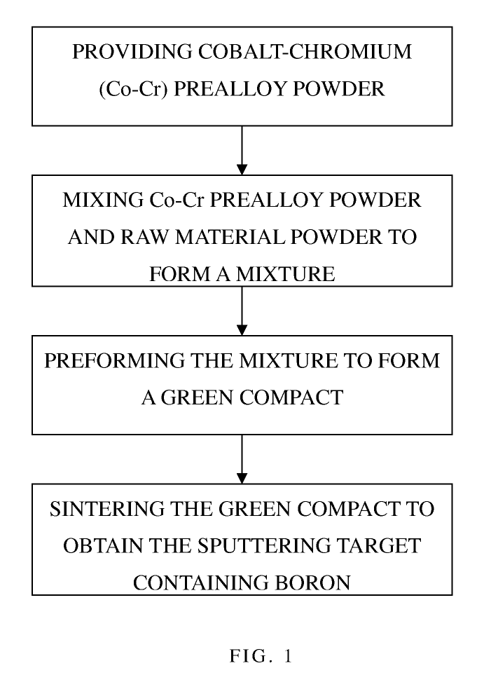

With reference to FIG. 1, a method for producing a sputtering target containing boron in accordance with the present invention comprises steps of providing cobalt-chromium (Co·Cr) prealloy powder, mixing Co·Cr prealloy powder and raw material powder containing boron and oxide to form a mixture, preforming the mixture to form a green compact, and sintering the green compact to obtain the sputtering target containing boron.

Preferably, the oxide is at least one selected from the group consisting of titanium dioxide (TiO₂), silicon dioxide (SiO₂), titanium sesquioxide (Ti₂O₃), chromium oxide (Cr₂O₃) and tantalum oxide (Ta₂O₅).

Preferably, the raw material powder further comprises platinum (Pt).

The step of sintering the green compact comprises sintering the green compact at 950˜1180° C. under 300˜425 bar.

The sputtering target containing boron comprises cobalt (Co), chromium (Cr), boron (B) and oxide and has an average boride particle size of less than 10 μm.

The sputtering target containing boron consists of cobalt (Co), chromium (Cr), boron (B) and oxide and has an average boride particle size of less than 5 μm.

A thin film in accordance with the present invention is deposited using a sputtering target of the present invention described above.

A magnetic recording media in accordance with the present invention comprises the thin film of the present invention described above.

Because Co·Cr pre alloy powder is provided, then is mixed with boron, oxide or the like, size and distribution of boride particles can be efficiently controlled. Therefore, Co, Cr, B or the like are uniformly distributed in the sputtering target.

### EXAMPLES

### Comparative Example 1

### Producing a Sputtering Target with 71.5 at % Co-17 at % Cr-4 at % B-7.5 at % Ti₂O₃

78.67 grams of Co powder (average particle size: 7 μm), 16.50 grams of Cr powder (average particle size: 20 μm), 0.81 grams of B powder (average particle size: 8 μm) and 4.02 grams of Ti₂O₃ powder (average particle size: 10 μm) were mixed and milled by an automatic milling machine for 30 minutes. Then, those powders were sieved with 60 meshes. The powders passing through 60 meshes were mixed homogeneously to form a mixture. The mixture was charged into a graphite mold and entered into a hydraulic press under 300 psi to form a green compact. The graphite mold with the green compact was put into a hot-pressing furnace and the green compact was sintered at 1100° C. under 362 bar for 180 minutes to obtain a sputtering target.

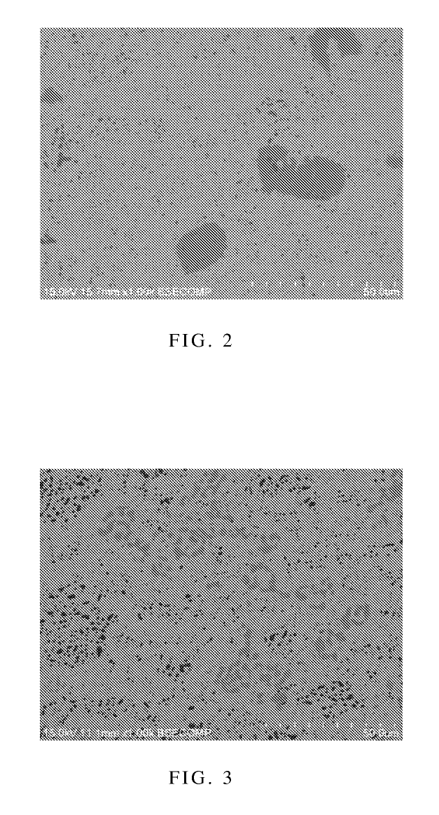

FIG. 2 shows a metallographic microscope image of the sputtering target formed by pure Co powder and pure Cr powder in comparative example 1. Therefore, boride particles are large and distributed irregularly and have an average particle size of about 20 μm.

### Example 1

### Producing a Sputtering Target of the Present Invention with 71.5 at % Co-17 at % Cr-4 at % B-7.5 at % Ti₂O₃

35.02 grams of Co powder (average particle size: 7 μm), 60.15 grams of 70 at % Co-30 at % Cr prealloy powder (average particle size: 15 μm), 0.81 grams of B powder (average particle size: 8 μm) and 4.02 grams of Ti₂O₃ powder (average particle size: 10 μm) were mixed and milled by an automatic milling machine for 30 minutes. Then, those powders were sieved with 60 meshes. The powders passing through 60 meshes were mixed homogeneously to form a mixture. The mixture was charged into a graphite mold and entered into a hydraulic press under 300 psi to form a green compact. The graphite mold with the green compact was put into a hot-pressing furnace and the green compact was sintered at 1100° C. under 362 bar for 180 minutes to obtain a sputtering target.

FIG. 3 shows a metallographic microscope of the sputtering target formed by Co·Cr prealloy powder in the example 1. Therefore, boride particles are reduced from 20 μm (comparative example 1) to 5 μm.

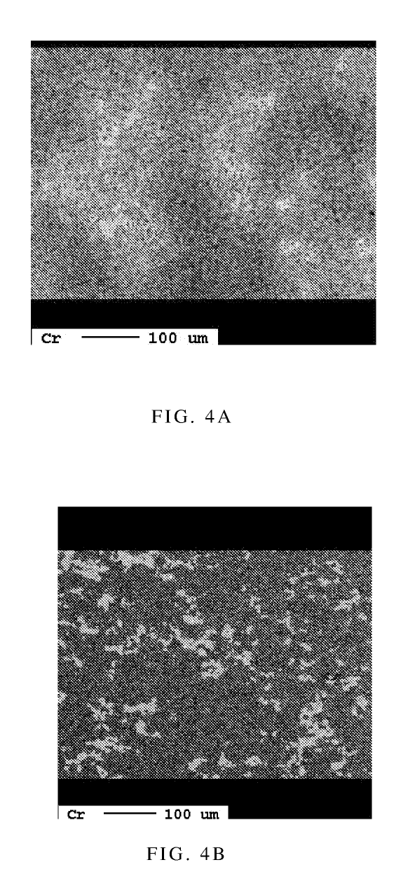

The sputtering targets of the comparative example 1 and example 1 were tested by electron probe microananlyser (EPMA). FIGS. 4A and 4B respectively show distributions of Cr in the sputtering targets of the comparative example 1 and example 1. It is definite that the distribution of Cr in the sputtering target of the example 1 is more uniform than that in the sputtering target of the comparative example 1. Therefore, the sputtering target produced by the method of the present invention has reduced boride particle size and has uniform distribution of composition.

### Example 2

### Producing a Sputtering Target of the Present Invention with 63 at % Co-17 at % Cr-12 at % Pt-5 at % B-3 at % TiO₂

51.35 grams of Co powder (average particle size: 7 μm), 12.23 grams of 70 at % Co-30 at % Cr prealloy powder (average particle size: 15 μm), 32.38 grams of Pt powder (average particle size: 5 μm), 0.75 grams of B powder (average particle size: 8 μm) and 3.30 grams of TiO₂ powder (average particle size: 1 μm) were mixed and were milled by an automatic milling machine for 30 minutes. Then, those powders were sieved with 60 meshes. The powders passing through 60 meshes were mixed homogeneously to form a mixture. The mixture was charged into a graphite mold and entered into a hydraulic press under 300 psi to form a green compact. The graphite mold with the green compact was put into a hot-pressing furnace and the green compact was sintered at 1100° C. under 362 bar for 180 minutes to obtain a sputtering target.

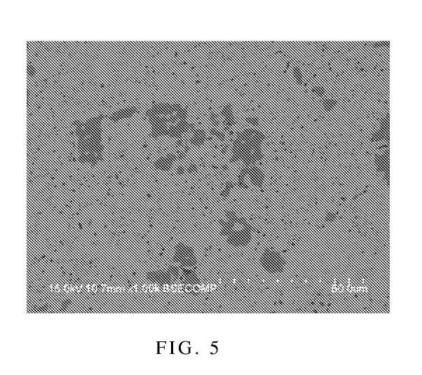

FIG. 5 shows a metallographic microscope of the Co·Cr—Pt—B—TiO₂ sputtering target formed by Co·Cr prealloy powder in the example 2. Boride particles have an average particle size of about 10 μm larger than that in Co·Cr—B—Ti₂O₃ sputtering target because Pt may allow diffusion of boron.

The method of the present invention comprises producing a sputtering target containing boron by CoCr prealloy powder. The boride particles exist in the CoCr prealloy powder, so an average particle size is reduced from 20 μm to 10 μm. Furthermore, the sputtering target of the present invention has uniform distribution of composition.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A method for producing a sputtering target containing boron, comprising steps of:
providing cobalt-chromium (Co·Cr) prealloy powder;
mixing Co·Cr prealloy powder and raw material powder containing boron and oxide to form a mixture;
preforming the mixture to form a green compact; and
sintering the green compact to obtain the sputtering target containing boron.

2. The method as claimed in claim 1, wherein the oxide is at least one selected from the group consisting of titanium dioxide (TiO₂), silicon dioxide (SiO₂), titanium sesquioxide (Ti₂O₃), chromium oxide (Cr₂O₃) and tantalum oxide (Ta₂O₅).

3. The method as claimed in claim 1, wherein the raw material powder further comprises platinum (Pt).

4. The method as claimed in claim 2, wherein the raw material powder further comprises platinum (Pt).

5. The method as claimed in claim 1, wherein the step of sintering the green compact comprises sintering the green compact at 950˜1180° C. under 300˜425 bar.

6. The method as claimed in claim 2, wherein the step of sintering the green compact comprises sintering the green compact at 950˜1180° C. under 300˜425 bar.

7. The method as claimed in claim 3, wherein the step of sintering the green compact comprises sintering the green compact at 950˜1180° C. under 300˜425 bar.

8. The method as claimed in claim 4, wherein the step of sintering the green compact comprises sintering the green compact at 950˜1180° C. under 300˜425 bar.

9. The method as claimed in claim 1, wherein the sputtering target containing boron has cobalt (Co), chromium (Cr), boron (B) and oxide and has an average boride particle size of less than 10 μm.

10. The method as claimed in claim 3, wherein the sputtering target containing boron consists of cobalt (Co), chromium (Cr), boron (B) and oxide 11 and has an average boride particle size of less than 5 μm.

11. A thin film characterized in that the thin film is deposited using a sputtering target containing boron produced by a method comprising steps of:
providing cobalt-chromium (Co·Cr) prealloy powder;
mixing Co·Cr prealloy powder and raw material powder containing boron and oxide to form a mixture;
preforming the mixture to form a green compact; and
sintering the green compact to obtain the sputtering target containing boron.

12. The thin film as claimed in claim 11, wherein the oxide is at least one selected from the group consisting of titanium dioxide (TiO₂), silicon dioxide (SiO₂), titanium sesquioxide (Ti₂O₃), chromium oxide (Cr₂O₃) and tantalum oxide (Ta₂O₅).

13. The thin film as claimed in claim 11, wherein the raw material powder further comprises platinum (Pt).

14. The thin film as claimed in claim 12, wherein the raw material powder further comprises platinum (Pt).

15. The thin film as claimed in claim 11, wherein the step of sintering the green compact comprises sintering the green compact at 950˜1180° C. under 300˜425 bar.

16. The thin film as claimed in claim 12, wherein the step of sintering the green compact comprises sintering the green compact at 950˜1180° C. under 300˜425 bar.

17. The thin film as claimed in claim 13, wherein the step of sintering the green compact comprises sintering the green compact at 950˜1180° C. under 300˜425 bar.

18. The thin film as claimed in claim 14, wherein the step of sintering the green compact comprises sintering the green compact at 950˜1180° C. under 300˜425 bar.

19. A magnetic recording media characterized in that the magnetic recording media contains a thin film as claimed in claim 11.

20. A magnetic recording media characterized in that the magnetic recording media contains a thin film as claimed in claim 18.
